(19) United States
(12) Patent Application Publication
(10) Pub. No.: US 2020/0125532 A1
(43) Pub. Date: Apr. 23, 2020

(54) FINGERPRINTS FOR OPEN SOURCE CODE GOVERNANCE

(71) Applicant: DiDi Research America, LLC, Mountain View, CA (US)

(72) Inventors: Liwei REN, San Jose, CA (US); Fangfang ZHANG, Cupertino, CA (US)

(21) Appl. No.: 16/718,082

(22) Filed: Dec. 17, 2019

Related U.S. Application Data
(63) Continuation-in-part of application No. 16/031,364, filed on Jul. 10, 2018.

(51) Int. Cl. G06F 16/13; G06F 16/14; G06F 8/71

(52) U.S. Cl. CPC G06F 16/137; G06F 8/71; G06F 16/152

(57) ABSTRACT

A method is provided for determining whether a software product includes open source code. A piece of open source code is obtained. A first sequence of the open source code is obtained. A first hash is generated based on the first sequence. A second sequence of the open source code is obtained. The second sequence is shifted from the first sequence. A second hash is generated based on the second sequence. A fingerprint for the open source code is generated based on the first hash and the second hash. The fingerprint is used to determine whether a software product includes the open source code.

### CROSS REFERENCE TO RELATED APPLICATIONS

This is a continuation-in-part application of prior Application Ser. No. 16/031,364 filed on Jul. 10, 2018, the contents of which are incorporated herein by reference in its entirety.

### TECHNICAL FIELD

The disclosure relates generally to generating fingerprints for open source code and using the fingerprints to determine whether a software product includes open source code.

### BACKGROUND

File fingerprints may be used to identify files. File fingerprints may be used in file management systems, such as data security systems or data loss prevention systems. For example, file fingerprints may be used in searching for files, classifying files, cleaning files (e.g., file deduplication), comparing file, filtering files (e.g., spam filtering), or protecting documents. If a file fingerprint is not unique, systems that rely on file fingerprint may not function properly. For example, if a system searches for files using file fingerprints and two different files have the same file fingerprint (collision), then a search for one of the files may output both files. File fingerprint collisions may result in improper functioning of data security systems or data loss prevention systems, such as improper security categorization of files or data leaks. File fingerprint collisions may cause waste of computing resources. For instance, significant CPU calculations may be required to detect file fingerprint collisions and recalculate file fingerprints for corresponding files. A file fingerprinting tool that quickly generates file fingerprints while reducing numbers of collisions is desirable.

### SUMMARY

One aspect of the present disclosure is directed to a method for generating file fingerprints. The method may comprise: obtaining a string of characters within a file; selecting a first sequence from the string of characters; generating a first hash based on the first sequence; selecting a second sequence from the string of characters based on the first sequence, wherein the second sequence is shifted from the first sequence; generating a second hash based on the second sequence; and generating a fingerprint for the file based on the first hash and the second hash.

Another aspect of the present disclosure is directed to a system for generating file fingerprints. The system may comprise one or more processors and a memory storing instructions. The instructions, when executed by the one or more processors, may cause the system to perform: obtaining a string of characters within a file; selecting a first sequence from the string of characters; generating a first hash based on the first sequence; selecting a second sequence from the string of characters based on the first sequence, wherein the second sequence is shifted from the first sequence; generating a second hash based on the second sequence; and generating a fingerprint for the file based on the first hash and the second hash.

In some embodiments, generation of the first hash may include a first calculation of a hash function based on characters within the first sequence; generation of the second hash may include a second calculation of the hash function based on characters within the second sequence; and the second calculation of the hash function may reuse a portion of the first calculation of the hash function.

In some embodiments, the hash function may include a rolling hash.

In some embodiments, selecting the first sequence from the string of characters may include: dividing the string of characters into string portions; and selecting one of the string portions as a first string portion, the first string portion including the first sequence.

In some embodiments, the string portions may comprise k-grams, the k-grams comprising sequences of k-characters from the string of characters.

In some embodiments, the first string portion may include a first sequence of k-characters from the string of characters; a second string portion may include a second sequence of k-characters from the string of characters; and the second sequence of k-characters may be selected by shifting from the first sequence of k-characters by n-characters.

In some embodiments, shifting from the first sequence of k-characters by n-characters may include shifting from the first sequence of k-characters by one or two characters in a reverse direction.

In some embodiments, shifting from the first sequence of k-characters by n-characters may include shifting from the first sequence of k-characters by one or two characters in a forward direction.

In some embodiments, obtaining the string of characters within the file may include: obtaining the file, the file including text; extracting the text of the file; and normalizing the extracted text of the file.

In another aspect of the disclosure, a system for generating file fingerprints may comprise one or more processors and a memory storing instructions. The instructions, when executed by the one or more processors, may cause the system to perform: obtaining a string of characters within a file; selecting a first sequence from the string of characters; generating a first hash based on the first sequence, wherein generation of the first hash includes a first calculation of a hash function based on characters within the first sequence; selecting a second sequence from the string of characters based on the first sequence, wherein the second sequence is shifted from the first sequence; generating a second hash based on the second sequence, wherein generation of the second hash includes a second calculation of the hash function based on characters within the second sequence and the second calculation of the hash function reuses a portion of the first calculation of the hash function; and generating a fingerprint for the file based on the first hash and the second hash.

In some embodiments, selecting the first sequence from the string of characters may include: dividing the string of characters into string portions, the string portions comprising k-grams, the k-grams comprising sequences of k-characters from the string of characters; and selecting one of the string portions as a first string portion, the first string portion including the first sequence.

In another aspect, a method is provided for determining whether a software product includes open source code. A piece of open source code is obtained. A first sequence of the open source code is obtained. A first hash is generated based on the first sequence. A second sequence of the open source code is obtained. The second sequence is shifted from the first sequence. A second hash is generated based on the second sequence. A fingerprint for the open source code is generated based on the first hash and the second hash. The fingerprint is used to determine whether a software product includes the open source code. In some embodiments, multiple fingerprints of the open source code may be used to determine whether a software product includes the open source code.

In some embodiments, the first sequence and the second sequence are shifted from each other by a predetermined length of code. In some embodiments, the first sequence and the second sequence overlap with each other. In some embodiments, a same hash function is used to generate the first hash and the second hash.

In some embodiments, the software product includes program code. A first sequence of the program code is obtained. A third hash is generated based on the first sequence of the program code. A second sequence of the program code is obtained. The second sequence of the program code is shifted from the first sequence of the program code by the predetermined length of code. A fourth hash is generated based on the second sequence of the program code. A fingerprint is generated for the software product based on the third hash and the fourth hash.

In some embodiments, a similarity value is calculated from the fingerprint or fingerprints of the software product and the fingerprint or fingerprints of the open source code is calculated. Whether the similarity value is greater than a predetermined threshold is determined. In response to determining that the similarity value is greater than the predetermined threshold, it is determined that the software product includes the open source code. In some embodiments, in response to determining that the software product includes the open source code, a licensing term for the software product is determined based on a licensing term of the open source code.

In yet another aspect, an apparatus is provided. The apparatus includes one or more processors, and a memory configured to store instructions executable by the one or more processors. The one or more processors are configured to execute the instructions to perform operations including: obtaining a piece of open source code; obtaining a first sequence of the open source code; generating a first hash based on the first sequence; obtaining a second sequence of the open source code, the second sequence being shifted from the first sequence; generating a second hash based on the second sequence; generating a fingerprint for the open source code based on the first hash and the second hash; and using the fingerprint to determine whether a software product includes the open source code. In some embodiments, multiple fingerprints of the open source code may be used to determine whether a software product includes the open source code.

In yet another aspect, a non-transitory computer-readable storage medium is provided. The non-transitory computer-readable storage medium stores instructions that, when executed by one or more processors, cause the one or more processors to perform operations including: obtaining a piece of open source code; obtaining a first sequence of the open source code; generating a first hash based on the first sequence; obtaining a second sequence of the open source code, the second sequence being shifted from the first sequence; generating a second hash based on the second sequence; generating a fingerprint for the open source code based on the first hash and the second hash; and using the fingerprint to determine whether a software product includes the open source code. In some embodiments, multiple fingerprints of the open source code may be used to determine whether a software product includes the open source code.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the disclosure. It is to be understood that the foregoing general description and the following detailed description are exemplary and explanatory only, and are not restrictive of the disclosure, as claimed.

### BRIEF DESCRIPTION OF THE DRAWINGS

Non-limiting embodiments of the disclosure may be more readily understood by referring to the accompanying drawings in which:

FIG. 1 illustrates an example environment for generating file fingerprints, in accordance with various embodiments of the disclosure.

FIG. 2 illustrates an example flow chart for obtaining a string of characters within a file, in accordance with various embodiments of the disclosure.

FIG. 3 illustrates an example string of characters and example string portions, in accordance with various embodiments of the disclosure.

FIG. 4A illustrates example selection of sequences from a string of characters, in accordance with various embodiments of the disclosure.

FIG. 4B illustrates example portions of sequences, in accordance with various embodiments of the disclosure.

FIG. 5 illustrates an example algorithm for generating file fingerprints, in accordance with various embodiments of the disclosure.

FIG. 6 illustrates a flow chart of an example method, in accordance with various embodiments of the disclosure.

FIG. 7 illustrates a block diagram of an example computer system in which any of the embodiments described herein may be implemented.

FIG. 8 is a schematic diagram illustrating a system for governing open source code, according to one example embodiment.

FIG. 9 is a flow chart illustrating a method for determining whether a software product includes open source code, according to one example embodiment.

FIG. 10 is a flow chart illustrating a method for generating a fingerprint for a software product, according to one example embodiment.

FIG. 11 is a flow chart illustrating a method for determining whether a software product includes open source code, according to one example embodiment.

### DETAILED DESCRIPTION OF THE EMBODIMENTS

Non-limiting embodiments of the present disclosure will now be described with reference to the drawings. It should be understood that particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present disclosure. Various changes and modifications obvious to one skilled in the art to which the present disclosure pertains are deemed to be within the spirit, scope and contemplation of the present disclosure as further defined in the appended claims.

The approaches disclosed herein improve functioning of computing systems that generate or use file fingerprints. By using the same hash function on two related sequences of characters, where one sequence is shifted from the other sequence, unique and robust file fingerprints may quickly be generated for files. The shifting of sequences provides for unique generation of hash to avoid collision while allowing prior calculation of hash to be reused in new calculation of hash. Computing systems that rely on file fingerprints to identify files, such as data security systems or data loss prevention systems, may better perform their tasks as file fingerprints are quickly generated with low probability of collision. For example, the generation of file fingerprints disclosed herein may enable data security systems to more accurately categorize files or data loss prevention systems to better prevent data leaks.

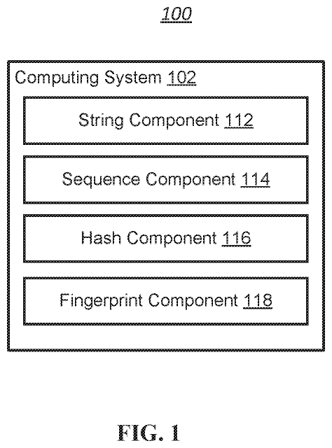

FIG. 1 illustrates an example environment 100 for generating file fingerprints, in accordance with various embodiments. The example environment 100 may include a computing system 102. The computing system 102 may include one or more processors and memory (e.g., permanent memory, temporary memory). The processor(s) may be configured to perform various operations by interpreting machine-readable instructions stored in the memory. The computing system 102 may include other computing resources. The computing system 102 may have access (e.g., via one or more connections, via one or more networks) to other computing resources.

The computing system 102 may include a string component 112, a sequence component 114, a hash component 116, and a fingerprint component 118. The computing system 102 may include other components. While the computing system 102 is shown in FIG. 1 as a single entity, this is merely for ease of reference and is not meant to be limiting. One or more components or one or more functionalities of the computing system 102 described herein may be implemented in a single computing device or multiple computing devices. In some embodiments, one or more components or one or more functionalities of the computing system 102 described herein may be implemented in one or more networks (e.g., enterprise networks), one or more endpoints, one or more servers, or one or more clouds.

The string component 112 may be configured to obtain one or more strings of characters within a file. A file may refer to a collection of data or information stored in one unit. Data or information may be stored as text of the file. For example, a file may include an electronic document. A file may be identified by one or more file identifiers, such as a file name or a file fingerprint. A file may include multiple characters. A character may refer to a symbol having one or more meanings, such as a symbol forming part of a word, depicting a letter, depicting a numeral, expressing grammatical punctuation, representing mathematical concepts, or representing other information. A character may be selected from letters of a set of letters, numerals of a numbering system, or special symbols (e.g., ampersand symbol “&,” percent symbol “%,” assign “@”). A string of characters may refer to a sequence of characters. A string of characters may include contiguous characters within a file. The characters/strings of characters within the file may form text of the file. Text of the file may refer to written, printed, or recorded information of the file. Text of the file may include visual representation of information included in the file. A string of characters (T) may have a length (L) and may include characters (c). A string of characters may be written as T=c₁ c₂ . . . c_{L}.

Obtaining a string of characters may include one or more of accessing, acquiring, analyzing, determining, examining, identifying, loading, locating, opening, receiving, retrieving, reviewing, storing, or otherwise obtaining the string of characters. The string component 112 may obtain the string of characters from one or more locations. For example, the string component 112 may obtain a string of characters from a storage location, such as an electronic storage of the computing system 102, an electronic storage of a device accessible via a network, another computing device/system (e.g., desktop, laptop, smartphone, tablet, mobile device), or other locations. The string component 112 may obtain the string of characters from the file.

In some embodiments, the string component 112 may obtain a string of characters within a file based on a file selection, a file detection, a file upload, or other actions relating to a file. For example, the string component 112 may obtain a string of characters within a file based on a selection of the file by a user or a computing system for fingerprint generation. The string component 112 may obtain a string of characters within a file based on a detection of the file by a computing system. The string component 112 may obtain a string of characters within a file based on the file being uploaded to a computing system. Other actions relating to a file may prompt the string component 112 to obtain a string of characters within the file.

In some embodiments, obtaining a string of characters within a file may include: obtaining the file, the file including text; extracting the text of the file; and normalizing the extracted text of the file. That is, the string component 112 may obtain a string of within a file by obtaining the file including text. The string component 112 may extract the text of the file and normalize the extracted text of the file. The string of characters may be selected from the normalized text of the file. Such process for obtaining strings of characters may enable the computing system 102 to generate file fingerprint for different types of files. For example, files may store information using different formats (e.g., documents of different formats) and the string component 112 may normalize text extracted from the files. For example, the string component 112 may obtain documents of different types (Word document, PDF document, PowerPoint document), extract text of the documents, and normalize the text extracted from the documents as sequences of UTF-8 characters. Such may result in the string component 112 obtaining standardized strings of characters from files that have text encoded differently.

The sequence component 114 may be configured to select multiple sequences from the string of characters. Multiple sequences may be selected from the string of characters to be used in generating a file fingerprint or file fingerprints. A sequence may refer to a portion of a string of characters. A sequence may include contiguous characters within a string of characters. Multiple sequences that are selected from the string of characters may be related to each other. For example, the sequence component 114 may select a first sequence from the string of characters and then select a second sequence from the string of characters based on the first sequence. The second sequence may be shifted from the first sequence. At least a portion of the second sequence may overlap with the first sequence. These sequences may be used to generate a file fingerprint or file fingerprints which is/are unique and robust (resilient to change) so that the file fingerprint(s) may uniquely identify the file.

Such selection of multiple sequences from the string of characters may facilitate fast generation of file fingerprints with low probability of collisions. Use of a single sequence of characters from a file to generate a file fingerprint may result in multiple files sharing the same file fingerprint. To reduce the probability of collisions, a single sequence of characters from a file may be processed using multiple functions, such as different hash functions, to generate information for the file fingerprint. However, use of multiple functions (e.g., different hash functions) may increase computation times to generate file fingerprints.

The selection of multiple sequences where one of the sequences is shifted from another sequence enables generation of unique and robust fingerprints. For instance, the first sequence may be selected from the string of characters by using a hash function on one or more sequences of the string. The sequence of the string that results in the hash of the sequence equaling 0 mod p (h=0 mod p) may be selected as the first sequence. The second sequence may be selected by shifting away from the first sequence in the forward or reverse direction by a certain number of characters. For example, the second sequence may be selected from the first sequence by shifting away from the first sequence in the forward or reverse direction by one or two characters. Such selection of the second sequence may allow for use of an iterative formula to quickly generate unique and robust file fingerprints. Other selection of the first sequence of from the string of characters are contemplated.

The hash component 116 may be configured to generate hashes based on the multiple sequences from the string of characters. For example, the hash component 116 may generate a first hash based on the first sequence and generate a second hash based on the second sequence. The hash component 116 may generate hashes using the same hash function, such as a rolling hash. The use of a rolling hash may enable quick calculations of hash as a prior calculation of the hash may be reused in a subsequent calculation of the hash. For example, the hash component 116 may generate the first hash by performing a first calculation of a hash function based on characters within the first sequence. The hash component 116 may generate the second hash by performing a second calculation of the same hash function based on characters within the second sequence. The hash component 116 may reuse a portion of the first calculation of the hash function in performing the second calculation of the hash function.

The length (w) of the sliding window of the rolling hash may be set or predefined. The hash function, such as the Karp-Rabin function, may be written as h(x₁, x₂, . . . , x_{w})=x₁b^{w-1}+x₂b^{w-2}+ . . . +x_{w-1}^{b}+x_{w}. This may be an iterative formula with only two additions and two multiplications where (−b^{w-1}) is a constant. For example, for k=2 to L−w+1, hₖ may be calculated from hₖ₋₁ with the iterative formula. That is, hₖ₋₁ may be used when calculating hₖ by the iterative formula. The values of b and p may be set/predefined, such as p=1021 and b=2. Use of other values and other hash functions, such as Adler-32, are contemplated.

Such generation of hashes using the same hash function for sequences that are shifted from each other may generate unique values for a file fingerprint. Rather than using two separate hash functions to generate values for a file fingerprint, the same hash function may be used to iteratively generate values for the file fingerprint. The shifting of sequences provides for unique generation of hash to avoid collision while allowing prior calculation of hash to be reused in new calculation of hash.

The fingerprint component 118 may be configured to generate a fingerprint for the file based on hashes of the multiple sequences, such as the first hash and the second hash. For example, the fingerprint component 118 may initialize a hash list and add one or more of the hash values calculated for the selected sequences to the hash list. For example, based on hₖ=0 mod p, the fingerprint component 118 may add hₖ₋₂ to the hash list (based on the second sequence being shifted from the first sequence by two characters in the reverse direction). The calculations for hₖ and hₖ₋₁ may be stored for reuse in new hash calculation, and the value for hₖ₋₂ may be discarded. In some embodiments, other information relating to the selected sequences or the hashes may be used in generating the fingerprint for the file. For instance, in addition to adding hₖ₋₂ to the hash list, k−2 may be added to the hash list (e.g., appending <hₖ₋₂, k−2>to the hash list). The hash list may form the set of fingerprints for the file.

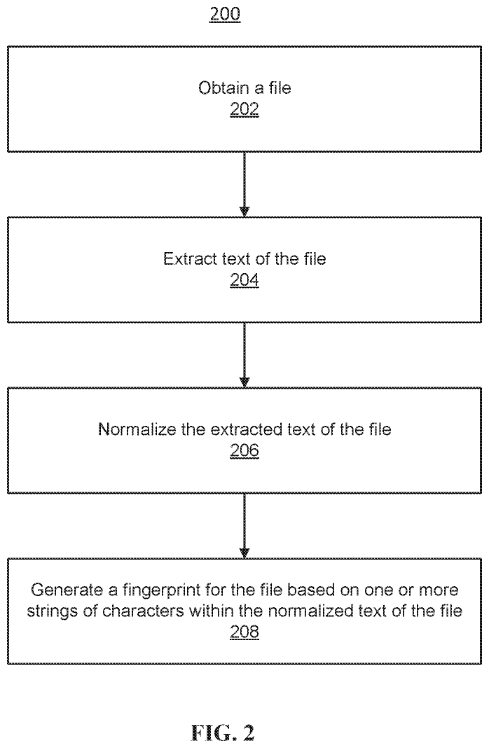

FIG. 2 illustrates an example flow chart 200 for obtaining a string of characters within a file, in accordance with various embodiments of the disclosure. At block 202, a file may be obtained. The file may include text. At block 204, the text of the file may be extracted. Text extraction may include extracting structured information from unstructured or semi-structured information within the file. At block 206, the extracted text of the file may be normalized. Text normalization may include conversion of the extracted text into a standard form, such as conversion of document into a plain text encoded in UTF-8. Text normalization may include removal of non-informative characters (e.g., white spaces). At block 208, a fingerprint or a set of fingerprints for the file may be generated based on one or more strings of characters within the normalized text of the file.

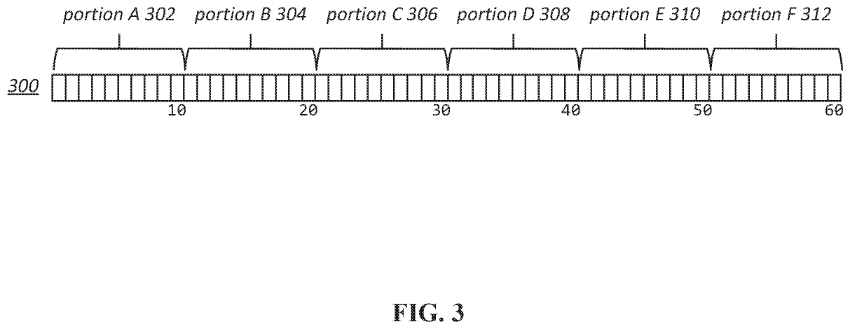

FIG. 3 illustrates an example string of characters 300 and example string portions 302, 304, 306, 308, 310, 312, in accordance with various embodiments of the disclosure. One or more sequences of characters may be selected from the string of characters 300 for use in generating file fingerprints. For example, the string of characters 300 may be divided into the string portions 302, 304, 306, 308, 310, 312. The string portions 302, 304, 306, 308, 310, 312 may individually comprise k-grams, where a k-gram comprises a sequence of k-characters (contiguous characters) from the string of characters 300. One of the string portions 302, 304, 306, 308, 310, 312 may be selected as a first string portion to be used in generating file fingerprints. The first string portion may include a first sequence of k-characters from the string of characters 300. For example, the string portion that includes a sequence of k-characters that result in hash equaling 0 mod p may be selected. Other selection of the first string portion are contemplated.

A second sequence may be selected based on the first sequence. The second string portion may include a second sequence of k-characters from the string of characters 300. The second sequence of k-characters may be selected by shifting from the first sequence of k-characters by n-characters. For example, the second sequence of k-characters may be selected by shifting from the first sequence of k-characters by one or two characters in a reverse direction (towards the start of the string of characters 300) or by shifting from the first sequence of k-characters by one or two characters in a forward direction (towards the end of the string of characters 300). In some embodiments, shifting in the reverse direction may be preferred as such shifting would include the beginning part of the first sequence in the second sequence.

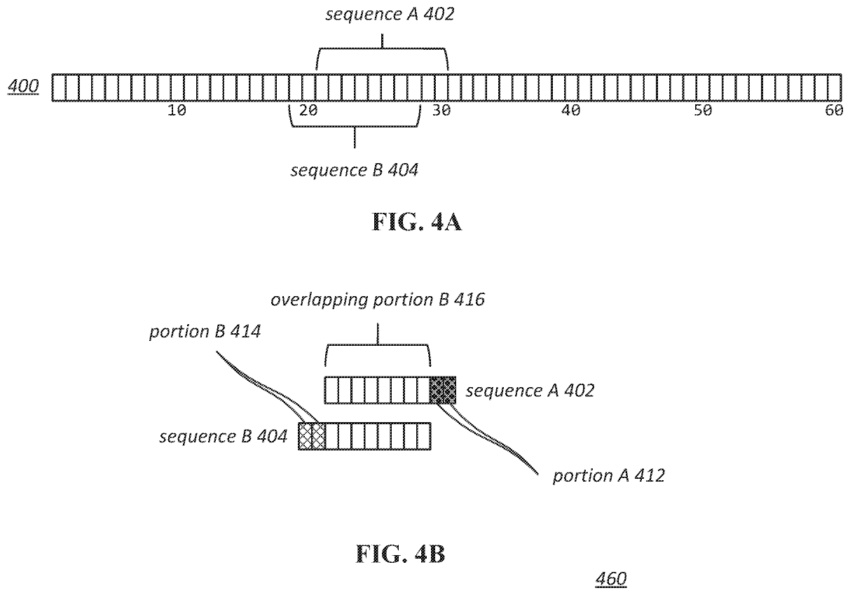

FIG. 4A illustrates example selection of sequences 402, 404 from a string of characters 400, in accordance with various embodiments of the disclosure. For example, the sequence A 402 may be selected from the string of characters 400 as a first sequence in generating values for file fingerprints. The sequence A 402 may include ten contiguous characters within the string of characters 400. A first hash may be generated based on the sequence A 402. The generation of the first hash may include a first calculation of a hash function based on the characters within the sequence A 402. The sequence B 404 may be selected from the string of characters 400 as a second sequence in generating values for file fingerprints. The sequence B 404 may include ten contiguous characters within the string of characters 400. The sequence B 404 may be selected by shifting from the sequence A 402 by two characters in the reverse direction. A second hash may be generated based on the sequence B 404. The generation of the second hash may include a second calculation of the hash function based on the characters within the sequence B 404. The second calculation of the hash function may reuse a portion of the first calculation of the hash function

FIG. 4B illustrates example portions 412, 414, 416 of the sequences 402, 404, in accordance with various embodiments of the disclosure. The sequence A 402 may include the portion A 412, which includes two characters at the end of the sequence A 402. The two characters in the portion A 412 may not be included in the sequence B 404. The sequence B 404 may include the portion B 414, which includes two characters at the start of the sequence B 404. The two characters in the portion B 414 may not be included in the sequence A 402. The sequence A 402 and the second B 404 may both include the overlapping portion B 416, which includes eight characters that are in both sequences 402, 404. The calculation of a hash function based on the sequence A 402 may reuse a portion of the calculation of the hash function based on the sequence B 404. That is, calculation of the hash function based on the sequence A 402 may reuse the computation of the hash function using the characters within the overlapping portion B 416. For instance, the calculation of the hash function based on the sequence A 402 may take the prior calculation of the hash function based on the sequence B 404, remove the contribution of the characters within the portion B 414 from the prior calculation, and add to the prior calculation the construction of the characters within the portion A 412.

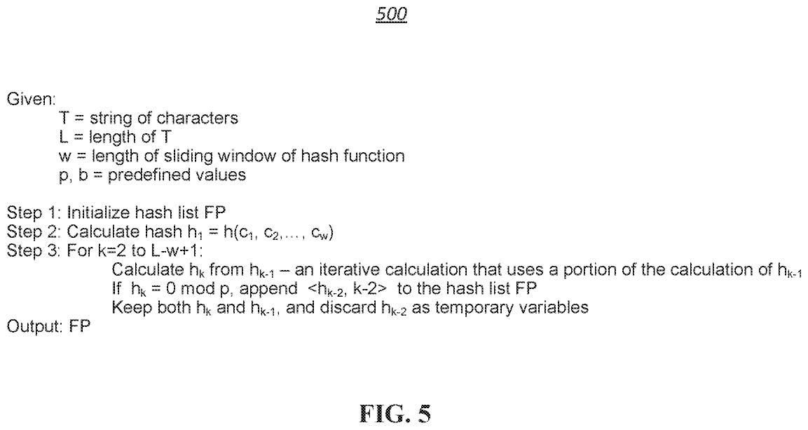

FIG. 5 illustrates an example algorithm 500 for generating file fingerprints, in accordance with various embodiments of the disclosure. Inputs to the algorithm 500 may include a string of characters (T) of length (L), a length of sliding window of rolling hash function (w), and predefined values (p, b). At step 1, a hash list (FP) may be initialized. At step 2, hash h₁=h(c₁, c₂, . . . , c_{w}) may be calculated, such as with Homer's rule. At step 3, for k=2 to L−w+1, the following may be performed: hₖ may be calculated from hₖ₋₁ using an iterative calculation that uses a portion of the calculation of hₖ₋₁. If hₖ=0 mod p, the values,<hₖ₋₂, k−2> may be appended to the hash list (FP). Both hₖ and hₖ₋₁ may be kept (stored) and hₖ₋₂ may be discarded as temporary variables. The output of the algorithm 500 may include the hash list (FP).

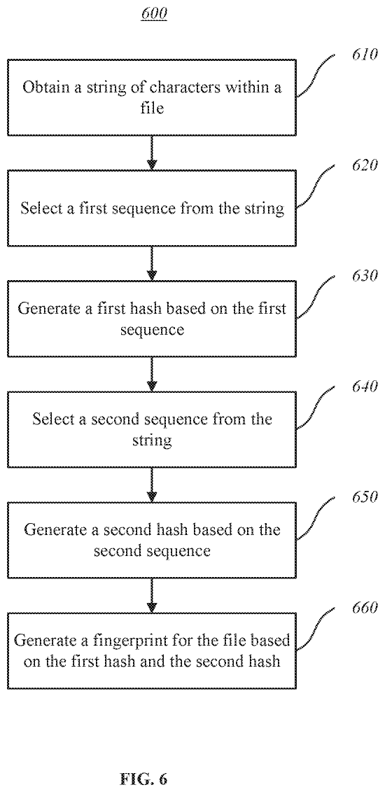

FIG. 6 illustrates a flowchart of an example method 600, according to various embodiments of the present disclosure. The method 600 may be implemented in various environments including, for example, the environment 100 of FIG. 1. The operations of the method 600 presented below are intended to be illustrative. Depending on the implementation, the method 600 may include additional, fewer, or alternative steps performed in various orders or in parallel. The method 600 may be implemented in various computing systems or devices including one or more processors.

With respect to the method 600, at block 610, a string of characters within a file may be obtained. At block 620, a first sequence may be selected from the string. At block 630, a first hash may be generated based on the first sequence. Generation of the first hash may include a first calculation of a hash function based on characters within the first sequence. At block 640, a second sequence may be selected from the string. The second sequence may be selected based on the first sequence and shifted from the first sequence. At block 650, a second hash may be generated based on the second sequence. Generation of the second hash may include a second calculation of the hash function based on characters within the second sequence. The second calculation of the hash function may reuse a portion of the first calculation of the hash function. At block 650, a fingerprint for the file may be generated based on the first hash and the second hash.

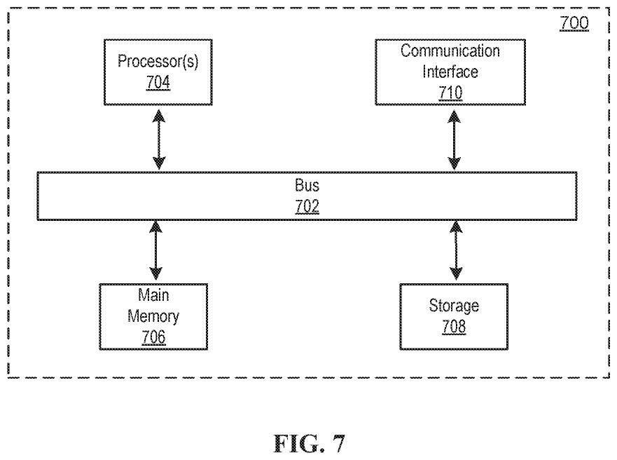

FIG. 7 is a block diagram that illustrates a computer system 700 upon which any of the embodiments described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 706, such as a random access memory (RAM), cache and/or other dynamic storage devices, coupled to bus 702 for storing information and instructions to be executed by processor(s) 704. Main memory 706 also may be used for storing temporary variables or other intermediate information during execution of instructions to be executed by processor(s) 704. Such instructions, when stored in storage media accessible to processor(s) 704, render computer system 700 into a special-purpose machine that is customized to perform the operations specified in the instructions. Main memory 706 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, and networked versions of the same.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor(s) 704 executing one or more sequences of one or more instructions contained in main memory 706. Such instructions may be read into main memory 706 from another storage medium, such as storage device 708. Execution of the sequences of instructions contained in main memory 706 causes processor(s) 704 to perform the process steps described herein. For example, the process/method shown in FIG. 6 and described in connection with this figure can be implemented by computer program instructions stored in main memory 706. When these instructions are executed by processor(s) 704, they may perform the steps as shown in FIG. 6 and described above. In alternative embodiments, hard-wired circuitry may be used in place of or in combination with software instructions.

The computer system 700 also includes a communication interface 710 coupled to bus 702. Communication interface 710 provides a two-way data communication coupling to one or more network links that are connected to one or more networks. As another example, communication interface 710 may be a local area network (LAN) card to provide a data communication connection to a compatible LAN (or WAN component to communicated with a WAN). Wireless links may also be implemented.

The fingerprint technologies described above may be employed for determining whether a software product includes open source code. In the software industry, it has been a practice to integrate open source code into a software product. Each open source is released under a license that users may have some specified rights and obligations to use, change, and distribute. Software developers may incorporate into their software products some or all portions of a piece of open source code. After a software product is ready for release, software developers/companies need to determine a license term for the software product. If open source code is included in the software product, configuring the license for the software product needs to consider the license terms of the open source code. Therefore, the software developers may desire to know, for example, which open source is used in the software product, which open source is modified in the software product, and/or which open source is redistributed to a third party. Techniques provided herein enable visibility for open source governance, to solve the above source code identification problems.

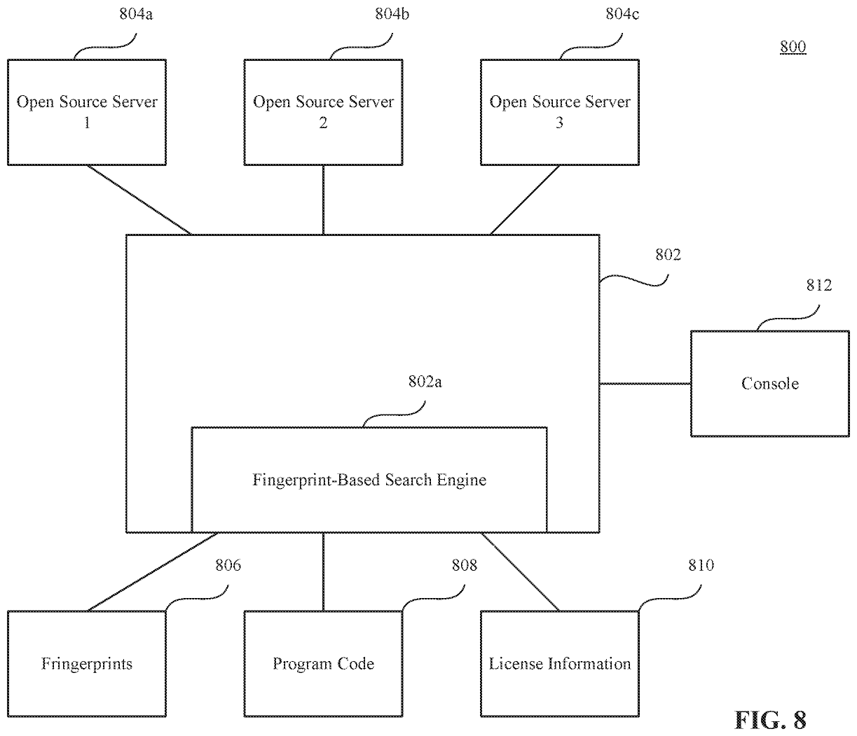

Reference is made to FIG. 8. FIG. 8 is a schematic diagram illustrating a system 800 for governing open source code according to one example embodiment. The system 800 includes a server 802 that includes a fingerprint-based search engine 802a. The system 800 further includes one or more open source server 804a-804c (collectively 804) coupled to the server 802. The open source servers 804 may be coupled to the server 802 through a private or public network. The server 802 is configured to obtain one or more pieces of open source code from the open source servers 804. For example, the server 802 may be configured to automatically download open source code from the open source servers 804 whenever a new version of open source code is placed at or uploaded to the open source servers 804. In some embodiments, the server 802 may download open source code upon a request from a user. Although three open source server 804a-804c are illustrated in FIG. 8, it is to be understood that fewer or more open source servers may be included in the system 800.

The system 800 further includes a fingerprint database 806, a program code database 808, and a license information database 810, all coupled to the fingerprint-based search engine 802a. The fingerprint database 806 is configured to store fingerprints for software products and one or more pieces of open source code. The program code database 808 is configured to store program code of software products and one or more pieces of open source code. The license information database 810 is configured to store license information for software products and one or more pieces of open source code. The system 800 may further include a console 812 configured to provide a user interface to allow a user to control the server 802.

The open source code and the software product may be written in a high-level (human readable) or low-level language (machine readable). The open source code and the software product may include a string of characters that are used to write the code. A character may refer to a symbol having one or more meanings, such as a symbol forming part of a word, depicting a letter, depicting a numeral, expressing grammatical punctuation, representing mathematical concepts, or representing other information. A character may be selected from letters of a set of letters, numerals of a numbering system, or special symbols.

The server 802 is configured to execute all tasks of open source code governance that includes downloading various source code packages from their cloud repositories (e.g., open source servers 804), and assigning them to the search engine 802a. The server 801 also accepts defined jobs from the console 812. For example, the server 802 may download a piece of open source code from one of the open source servers 804 and forward it to the fingerprint-based search engine 802a for processing.

The fingerprint-based search engine 802a then obtains a first sequence of the open source code and generate a first hash based on the first sequence. The fingerprint-based search engine 802a also obtains a second sequence of the open source code and generates a second hash based on the second sequence. The second sequence is shifted from the first sequence. In some embodiments, the first sequence and the second sequence are shifted from each other by a predetermined length of code. For example, the second sequence may be shifted in a forward or reverse direction with respect to the first sequence. In some embodiments, the first sequence and the second sequence partially overlap with each other.

In some embodiments, the same hash function, such as a rolling hash, is used to generate the first hash and the second hash. The use of a rolling hash may enable quick calculations of hash values, as a prior calculation of the hash may be reused in a subsequent calculation of the hash. For example, the fingerprint-based search engine 802a may generate the first hash by performing a first calculation of a hash function based on characters within the first sequence. The fingerprint-based search engine 802a may generate the second hash by performing a second calculation of the same hash function based on characters within the second sequence. The fingerprint-based search engine 802a may reuse a portion of the first calculation of the hash function in performing the second calculation of the hash function. This would save computing resources and allow the fingerprint-based search engine 802a to quickly generate hashes for open source code.

After the first hash and the second hash are generated, the fingerprint-based search engine 802a may generate a fingerprint or fingerprints for the open source code based on them. The fingerprint(s) may serve as a unique identifier for the open source code. In some embodiments, the fingerprint-based search engine 802a may generate a set of hashes based on multiple sequences of the open source code, and generate one or more fingerprints as unique identifiers for the open source code. The fingerprint-based search engine 802a saves the piece of open source code to the program code database 808 and save the generated fingerprint(s) to the fingerprint database 806. The fingerprint-based search engine 802a may generate an index table linking the fingerprint(s) to the piece of open source code. In some embodiments, the fingerprint-based search engine 802a may extract and include, in the index table, attributes of the piece of open source code, such as an author, a developer/company name, a version identifier, a publication date or time, etc. The server 802 may also download license terms for the piece of open source code for the fingerprint-based search engine 802a to save to the license information database 810. The index table may include entries linking the piece of open source code to its fingerprint(s), attributes, and license terms.

The fingerprint-based search engine 802a may generate a fingerprint for the piece of open source code based on hashes of the multiple sequences, such as the first hash and the second hash. For example, in a simple form, the index table that includes multiple hashes generated from multiple sequences of open source code can be used as a fingerprint for the open source code. In one embodiment, the calculations for the first hash and second hash may be stored for reuse in new hash calculation, and the value for one of the hashes may be discarded when a subsequent hash is calculated and stored. In some embodiments, other information relating to the selected sequences or the hashes may be used in generating the fingerprint for the open source code as discussed above.

The techniques of generating a fingerprint for a piece of open source code may be performed for all pieces of open source code available to the server 802 in a similar manner. For example, the server 802 may obtain all available pieces of open source code from the Internet or other public networks. The generated fingerprints for the open source code may be employed to determine whether a software product includes a portion of a piece of open source code. For example, the fingerprint-based search engine 802a may obtain a software product that includes program code. The fingerprint-based search engine 802a then obtains a first sequence of the program code and generate a third hash based on the first sequence of the program code. The fingerprint-based search engine 802a obtains a second sequence of the program code and generates a third hash based on the second sequence of the program code. The second sequence of the program code is shifted from the first sequence of the program code by a predetermined length of code. In some embodiments, the shift between the sequences of program code is configured to be the same as that between the sequences of the open source code. The fingerprint-based search engine 802a generates a fingerprint for the software product based on the third hash and the fourth hash.

The fingerprint-based search engine 802a is configured to compare the fingerprint(s) for the software product to the fingerprint(s) for one or more pieces of open source code to determine whether the software product include any open source code. For example, the fingerprint-based search engine 802a may calculate a similarity value or similarity values from the fingerprint(s) of the software product and a fingerprint or fingerprints for a piece of the open source code. In some embodiments, the similarity value may be scaled to between zero and one. The fingerprints are less likely related to each other when the similarity value is close to zero. In contrast, when the similarity value is close to one, the fingerprints are highly likely related to each other. The fingerprint-based search engine 802a then determines whether the similarity value is greater than a predetermined threshold. For example, the predetermined threshold may be 50% or more, 60% or more, 70% or more, 80% or more, 90% or more, 95% or more, or 99% or more. When the similarity value is greater than the predetermined threshold, the fingerprint-based search engine 802a determines that the software product includes the open source code. In some embodiments, the fingerprint-based search engine 802a may generate an alert for the user such that the user may take necessary measures in planning release of the software product that includes the open source code.

In some embodiments, a project of open source code may contain a plurality of files. The fingerprint-based search engine 802a may generate one or more fingerprints for each of the files of the open source code. A software product may also contain a plurality of files. The fingerprint-based search engine 802a may generate one or more fingerprints for each of the files of the software product. If the set of fingerprints of a file from the software product have some common features with the set of fingerprints of a file from the open source project, the fingerprint-based search engine 802a can determine that the software product contains some open source codes.

In some embodiments, when the fingerprint-based search engine 802a determines that the software product includes the open source code, it may further be configured to determine whether the open source code included in the software product is modified. For example, the fingerprint-based search engine 802a can identify the program code of the software product that corresponds to the fingerprint of the software product. The fingerprint-based search engine 802a further obtains the open source code from the program code database 808 and compares the program code of the software product with the open source code. The fingerprint-based search engine 802a determines that the open source code included in the software product is modified when it detects variations between the program code of software product and the open source code.

When the similarity value is not greater than the predetermined threshold, the fingerprint-based search engine 802a determines that the software product does not include the open source code. In some embodiments, the fingerprint-based search engine 802a may generate another alert for the user if it determines that the software product does not includes the open source code so that the user may decide whether to manually intervene to further examine the possibility that the software product uses a minor portion of the open source code.

In some embodiments, the fingerprint-based search engine 802a may be configured to determine a licensing term for the software product. For example, when the fingerprint-based search engine 802a determines that the software product includes a piece of open source code, the fingerprint-based search engine 802a may generate a licensing term for the software product based on a licensing term for the piece of open source code. A licensing term for open source code may require a user of the open source code to follow certain redistribution, use, or modification rules. The fingerprint-based search engine 802a can use an index table as described above to identify a licensing term for the open source code in the license information database 810. The fingerprint-based search engine 802a may extract and include all or portions of the licensing term for the open source code in the licensing term for the software product. In some embodiments, the fingerprint-based search engine 802a may extract and present relevant portions of the licensing term for the open source code to the user to enable the user to review and modify the licensing terms for the software product.

The techniques presented herein provide solutions to determine whether a software product includes open source code, which allows a licensing term for the software product to comply with a licensing term of the open source code. The techniques also provide solutions to determine which open source is used in the software product and/or which open source is modified in the software product.

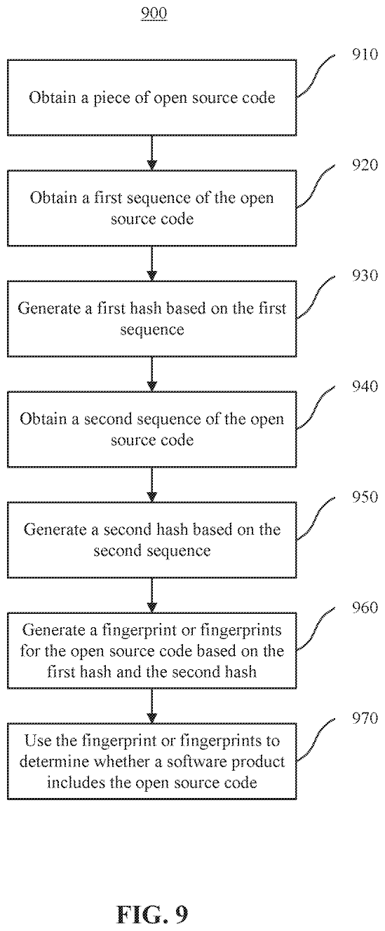

Reference is made to FIG. 9. FIG. 9 is a flow chart illustrating a method 900 for determining whether a software product includes open source code, according to one example embodiment. The method 900 may be performed by a server, such as the server 802 in FIG. 8. At 910, the server obtains a piece of open source code. The piece of open source code may be a new version or an update to an older version of the piece. At 920, the server obtains a first sequence of the open source code. For example, the server may parse the piece of open source code to obtain a string of characters or numbers. The server then select a first sequence from the string. At 930, the server generates a first hash based on the first sequence. For example, the server may hash the first sequence with a hash function to generate the first hash for the first sequence. Any hash function may be employed to generate the first hash. In one embodiment, a rolling hash function may be used as it allows a subsequent hash calculation to reuse results from prior hash calculations.

At 940, the server obtains a second sequence of the open source code. The second sequence is different from the first sequence. In some embodiments, the second sequence is shifted from the first sequence. The second sequence may be shifted from the first sequence by a predetermined length of code in a forward or reverse direction with respect to the first sequence. At 950, the server generates a second hash based on the second sequence. For example, the server may hash the second sequence with a hash function to generate the second hash for the second sequence. The hash function may be the same as that used to hash the first sequence. At 960, the server generates a fingerprint or fingerprints for the open source code, which may be referred to as a file, based on the first hash and the second hash. For example, the fingerprint for the open source code may be a list of hashes including the first hash and the second hash. In some embodiments, the fingerprint for the open source code may include more than two hashes generated from sequences of the open source code. At 970, the server uses the fingerprint(s) to determine whether a software product includes the open source code. For example, the server may compare the fingerprint(s) for the open source code with a fingerprint or fingerprints for the software product. If the fingerprint for the open source code are similar to the fingerprint for the software product (e.g., having a common subset of fingerprints), the server determines that the software product includes the open source code. If they are not similar, the server determines that the software product does not include the open source code.

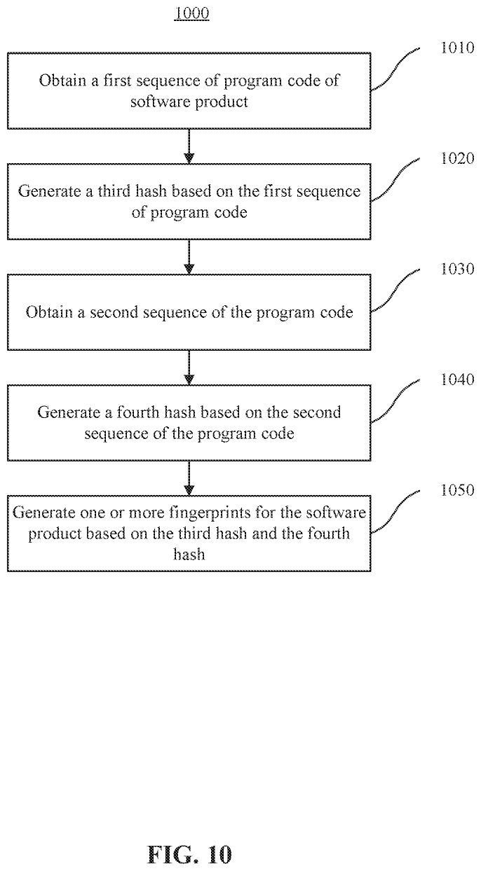

Reference is made to FIG. 10. FIG. 10 is a flow chart illustrating a method 1000 for generating a fingerprint for a software product, according to one example embodiment. The method 1000 may be performed by a server, such as the server 802 in FIG. 8. At 1010, the server obtains a first sequence of program code of the software product. For example, the server may parse the program code to obtain a string of characters or numbers. The server then select a first sequence from the string. At 1020, the server generates a third hash based on the first sequence. For example, the server may hash the first sequence of the program code with a hash function to generate the third hash for the first sequence. At 1030, the server obtains a second sequence of the program code. The second sequence is shifted from the first sequence. The second sequence may be shifted from the first sequence by a predetermined length of code in a forward or reverse direction with respect to the first sequence. At 1040, the server generates a fourth hash based on the second sequence. For example, the server may hash the second sequence with a hash function to generate the fourth hash for the second sequence. The hash function may be the same as that used to hash the first sequence, and the same as the one used at 930 and 950 in FIG. 9. At 1050, the server generates a fingerprint or fingerprints for the program code based on the third hash and the fourth hash. For example, the fingerprint(s) for the program code may be a list of hashes including the third hash and the fourth hash. In some embodiments, the fingerprint for the program code may include more than two hashes generated from sequences of the program code.

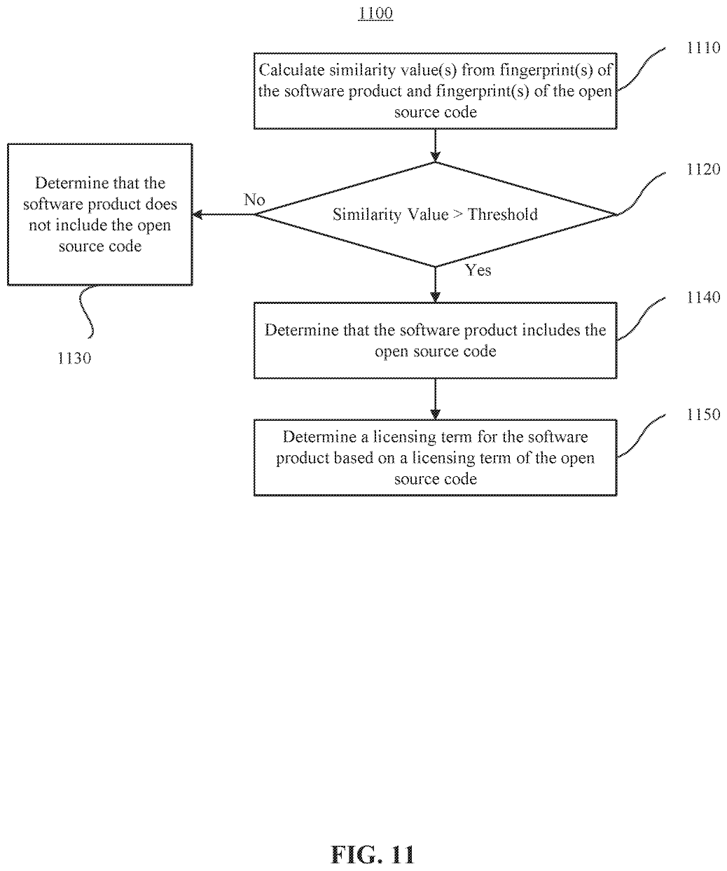

Reference is made to FIG. 11. FIG. 11 is a flow chart illustrating a method 1100 for determining whether a software product includes open source code, according to one example embodiment. The method 1100 may be performed by a server, such as the server 802 in FIG. 8. At 1110, the server calculates a similarity value or similarity values from the fingerprint(s) of the software product and the fingerprint(s) of the open source code. At 1120, the server determines whether the similarity value is greater than a predetermined threshold. If the similarity value is not greater than the predetermined threshold (No at 1120), at 1130 the server determines that the software product does not include the open source code. If the similarity value is greater than the predetermined threshold (Yes at 1120), at 1140 the server determines that the software product includes the open source code. In some embodiments, after the server determines that the software product includes the open source code, at 1150 the server determines a licensing term for the software product based on a licensing term of the open source code.

The computer system 700 shown in FIG. 7 may be employed as a server to perform the methods 900, 1000, and 1100.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Certain embodiments are described herein as including logic or a number of components/modules. Components may constitute either software components/modules (e.g., code embodied on a machine-readable medium) or hardware components/modules (e.g., a tangible unit capable of performing certain operations which may be configured or arranged in a certain physical manner). For example, each of the operations in FIGS. 9-11 may be performed by a module.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A method comprising:
obtaining a piece of open source code;
obtaining a first sequence of the open source code;
generating a first hash based on the first sequence;
obtaining a second sequence of the open source code, the second sequence being shifted from the first sequence;
generating a second hash based on the second sequence;
generating a fingerprint for the open source code based on the first hash and the second hash; and
using the fingerprint to determine whether a software product includes the open source code.

2. The method according to claim 1, wherein the first sequence and the second sequence are shifted from each other by a predetermined length of code.

3. The method according to claim 2, wherein the first sequence and the second sequence overlap with each other.

4. The method according to claim 2, further comprising:
using a same hash function to generate the first hash and the second hash.

5. The method according to claim 4, wherein the software product includes program code, the method further comprising:
obtaining a first sequence of the program code;
generating a third hash based on the first sequence of the program code;
obtaining a second sequence of the program code, the second sequence of the program code being shifted from the first sequence of the program code by the predetermined length of code;
generating a fourth hash based on the second sequence of the program code; and
generating a fingerprint for the software product based on the third hash and the fourth hash.

6. The method according to claim 5, further comprising:
calculating a similarity value from the fingerprint of the software product and the fingerprint of the open source code;
determining whether the similarity value is greater than a predetermined threshold; and
in response determining that the similarity value is greater than the predetermined threshold, determining that the software product includes the open source code.

7. The method according to claim 6, further comprising:
in response to determining that the software product includes the open source code, determining a licensing term for the software product based on a licensing term of the open source code.

8. An apparatus comprising:
one or more processors;
a memory configured to store instructions executable by the one or more processors, wherein the one or more processors are configured to execute the instructions to perform operations including:
obtaining a piece of open source code;
obtaining a first sequence of the open source code;
generating a first hash based on the first sequence;
obtaining a second sequence of the open source code, the second sequence being shifted from the first sequence;
generating a second hash based on the second sequence;
generating a fingerprint for the open source code based on the first hash and the second hash; and
using the fingerprint to determine whether a software product includes the open source code.

9. The apparatus according to claim 8, wherein the first sequence and the second sequence are shifted from each other by a predetermined length of code.

10. The apparatus according to claim 9, wherein the first sequence and the second sequence overlap with each other.

11. The apparatus according to claim 9, wherein the operations further include:
using a same hash function to generate the first hash and the second hash.

12. The apparatus according to claim 11, wherein the software product includes program code, and the operations further include:
obtaining a first sequence of the program code;
generating a third hash based on the first sequence of the program code;
obtaining a second sequence of the program code, the second sequence of the program code being shifted from the first sequence of the program code by the predetermined length of code;
generating a fourth hash based on the second sequence of the program code; and
generating a fingerprint for the software product based on the third hash and the fourth hash.

13. The apparatus according to claim 12, wherein the operations further include:
calculating a similarity value from the fingerprint of the software product and the fingerprint of the open source code;
determining whether the similarity value is greater than a predetermined threshold; and
in response determining that the similarity value is greater than the predetermined threshold, determining that the software product includes the open source code.

14. The apparatus according to claim 13, wherein the operations further include:
in response to determining that the software product includes the open source code, determining a licensing term for the software product based on a licensing term of the open source code.

15. A non-transitory computer-readable storage medium storing instructions that, when executed by one or more processors, cause the one or more processors to perform operations including:
obtaining a piece of open source code;
obtaining a first sequence of the open source code;
generating a first hash based on the first sequence;
obtaining a second sequence of the open source code, the second sequence being shifted from the first sequence;
generating a second hash based on the second sequence;
generating a fingerprint for the open source code based on the first hash and the second hash; and
using the fingerprint to determine whether a software product includes the open source code.

16. The non-transitory computer-readable storage medium according to claim 15, wherein the first sequence and the second sequence are shifted from each other by a predetermined length of code.

17. The non-transitory computer-readable storage medium according to claim 16, wherein the first sequence and the second sequence overlap with each other.

18. The non-transitory computer-readable storage medium according to claim 16, wherein the operations further include:
using a same hash function to generate the first hash and the second hash.

19. The non-transitory computer-readable storage medium according to claim 18, wherein the software product includes program code, and the operations further include:
obtaining a first sequence of the program code;
generating a third hash based on the first sequence of the program code;
obtaining a second sequence of the program code, the second sequence of the program code being shifted from the first sequence of the program code by the predetermined length of code;
generating a fourth hash based on the second sequence of the program code; and
generating a fingerprint for the software product based on the third hash and the fourth hash.

20. The non-transitory computer-readable storage medium according to claim 19, wherein the operations further include:
calculating a similarity value from the fingerprint of the software product and the fingerprint of the open source code;
determining whether the similarity value is greater than a predetermined threshold; and
in response determining that the similarity value is greater than the predetermined threshold, determining that the software product includes the open source code.
